(19) United States
(12) Patent Application Publication
(10) Pub. No.: US 2001/0054030 A1
(43) Pub. Date: Dec. 20, 2001

(54) Electronic mail apparatus and system for evaluating effect of the mail

(75) Inventor: Toshikatsu Igarashi, Gunma (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,848

(22) Filed: Mar. 30, 2001

(30) Foreign Application Priority Data
Jun. 13, 2000 (JP) 2000-177496

(51) Int. Cl. G06F 17/00

(52) U.S. Cl. 705/401

(57) ABSTRACT

An advertisement mail site generates an e-mail containing a command. The e-mail is sent to multiple users. The command works to acquire how long the mail is being read at each user terminal. The obtained information or view duration is embedded in a reply e-mail, which is sent back to the advertisement mail site. The view duration tends to indicate how much the user felt interested in the sent e-mails. The site acts as an agent for companies or sponsors to send e-mail based direct mails. The charge for the service billed to the sponsors is calculated based on the view duration of each e-mail.

### BACKGROUND OF THE INVENTION

1. Field of the Invention

This invention relates to an electronic mail or e-mail related technology, especially to an e-mail transmission method, apparatus and system.

2. Description of the Related Art

So-called DM or direct mail has been a means for advertisement in many countries. In recent years, e-mail became a new tool for DM, as more and more people has come to use the e-mail system and generally the cost for sending e-mails is lower than real mail. New agency business became known for sending e-mail type DM (hereinafter referred to simply as “e-DM”) on request from sponsors. In this type of business, it is important to objectively estimate the effect of the e-DM both for the marketing strategy of the sponsor and for the customer development of the agency.

It is naturally possible to assess the effect by counting the number of users who read the e-DM. To realize this, it is known that a POP (post office protocol) server is implemented with a report function. The server can inform the e-DM sender of who has downloaded the e-DM. The number of the download gives a rough estimation of the effect.

In another known method, a mailer program at the user end has a function to report only when the user opens a mail. In this case, the report is not made when the user merely downloaded the mail, but when the user actually viewed the mail. In this method the estimation may become more accurate.

It is observed, however, the user may intensively read the “opened” mail or may discard it immediately after opening it. Certain mailer software handles mails as “opened” simply when the user scrolled the title areas of the mails. In such a case, the report from the mailer is not very reliable. The charge to be billed to the sponsors is usually calculated evenly for intensively read e-DMs and others. Sponsors have to pay the charge even when they cannot feel the effect directly. Unclearness of the effect, which may be fatal in the advertising field, certainly hampers the extension of the e-DM business.

### SUMMARY OF THE INVENTION

It is therefore an object of the present invention to provide an e-mail technique to objectively estimate the effect of the e-DMs or more generally e-mails.

According to one aspect of the present invention, an electronic mail apparatus is provided. The apparatus may be implemented in a server for transmitting e-mails and comprises a mail transmitting unit which sends e-mails, a mail receiving unit which receives e-mails and a charge processor which manages charge of service for transmitting e-mails. The mail receiving unit includes an additional information detector to detect information regarding start time and end time of view of the received e-mail, the information having been embedded in the received e-mail. The charge processor includes a charge information generator to calculate the service charge for transmitting the e-mail based on the duration of the view (hereinafter also referred simply to “view duration”). “Service for transmitting e-mails” may include drafting, editing and/or sending e-mails on request from others such as advertisement sponsors.

In this configuration, the information regarding start time and end time of the mail view, if any, is detected when the mail receiving unit receives an e-mail. Charge is then calculated using the information or the view duration. When the e-mail is an e-DM, it can be judged that the user read the e-DM more intensively when the view duration becomes longer. The effect of e-mails thus can be assessed.

The mail transmitter may further include an extended command addition unit which embeds in the e-mail to be transmitted a command to instruct to obtain the start time and the end time of the view. The command may be:

1) a description which can be processed at the receiving end such as an instruction, script, code and so on executable by an arbitrary interpreter implemented in the e-mail receiving side,

2) a description which makes a program, or the execution result thereof, for obtaining the start time and end time be incorporated in the e-mail receiving side, such as an HTML/XML tag utilizing CGI or common gateway interface at a web server, a Java applet and a function call to an ASP or application service provider service,

3) a plug-in program to be installed to the mailer at the e-mail receiving side, or

4) a program which, by user's click, starts to reside on memory, after having been received in the form of an file attached to an e-mail and which functions to obtain the start time and the end time.

The charge processor may further includes a request receiving unit which receives request for distributing advertisement using e-mails, a table recording a sponsor who sent the request, a mailing list to be referred to when the e-mails are sent, and a charge scheme table which defines the service charge based on the duration of the view of the e-mail containing the advertisement. The charge information addition unit may calculate the charge referring to the detected information and the scheme table.

According to another aspect of the present invention, an e-mail apparatus is provided. The apparatus may be realized as a user terminal and comprises a mail transmitting unit which sends e-mails, a mail receiving unit which receives e-mails and an additional information generator which generates additional information to embed in the e-mails to be sent. The mail receiving unit includes an extended command detector to detect a command embedded in the received e-mail instructing to obtain start time and end time of view of the received e-mail and the additional information generator, instructed by the command, generates the information by measuring duration of the view of the received e-mail. The “extended command” is directed at a newly adopted command employed in this aspect of the invention.

In this configuration, the command for obtaining start time and end time of the mail view, if any, is detected when the mail receiving unit receives an e-mail. The additional information is then generated by the command which acts to obtain the view duration of the e-mail. The information is embedded in a reply mail of the e-mail or in another e-mail and may be automatically sent back to the sender of the original e-mail.

According to another aspect of the present invention, an e-mail system is provided. The system comprises a first e-mail apparatus and a second e-mail apparatus. The first apparatus may be an e-DM sender end and the second apparatus may be an e-DM receiver or general user terminal.

The first apparatus comprises a functional block to embed a command in an e-mail to be sent to the second apparatus. The command requests the second apparatus to return the view duration of the sent e-mail and another functional block to detect the view duration included in an e-mail returned from the second apparatus.

The second apparatus, on the other hand, comprises a functional block to detect the command embedded in the e-mail sent from the first apparatus, another block to interpret the detected command and to measure the view duration and still another block to include the measured value in a reply mail and to send it back to the first apparatus. Each block may be designed based on an arbitrary combination of hardware and software.

The first apparatus, on receipt of the replied mail, detects the view duration and uses for estimating how intensively the original mail was read at the second apparatus or for any other purposes. In one embodiment, charge information for preparing and/or transmitting the original e-DM is created for the agent to bill the sponsor.

According to still another aspect of the present invention, an e-mail communication method is provided. The method comprises sending an e-mail from a first apparatus, receiving the e-mail at a second apparatus, acquiring duration of view of the e-mail at the second apparatus and calculating charge by referring to a predetermined charge scheme using the acquired duration as a key to the scheme. In this method, the charge can be set based on how deeply the user of the second apparatus felt interested in the e-mail. The charge tends to meet the effect of an e-DM.

This summary of the invention does not necessarily describe all necessary features so that the invention may also be a sub-combination of these described features.

### BRIEF DESCRIPTION OF THE DRAWINGS

FIG. 1 illustrates the entire network system to which one preferred embodiment of the present invention is applied.

FIG. 2 is a block diagram of an e-mail apparatus provided in an advertisement mail site.

FIG. 3 shows an internal block of a charge processor of FIG. 2.

FIG. 4 shows the data structure of a sponsor table.

FIG. 5 shows data structure of a mailing list.

FIG. 6 shows the data structure of a charge scheme table.

FIG. 7 shows the data structure of an additional information table.

FIG. 8 illustrates a bill to be sent to a sponsor.

FIG. 9 is a block diagram realized at the user end.

FIG. 10 is a block diagram of an additional information generating unit.

FIG. 11 is a flow chart of the e-mail system according to one embodiment of the present invention.

### DETAILED DESCRIPTION OF THE INVENTION

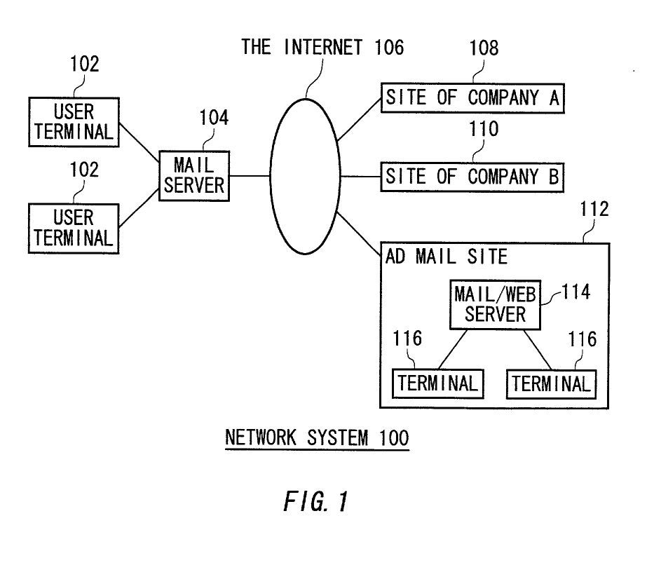

FIG. 1 shows an entire network system 100 to which an e-mail technology according to one embodiment of the present invention is applied. Multiple user terminals 102 are connected to a mail server 104, which is connected to the Internet 106. The sites 108, 110 of Company A and B, respectively, as examples of many companies, and a advertisement mail site 112 acting as an agent to send e-DMs for the companies are also connected to the Internet 106.

The advertisement mail site 112 comprises a mail/Web server 114 to serve for the user terminals 102 and other nodes, and terminals 116 connected to the mail/Web server 114 via a local area network or LAN. The mail server 104 exchanges e-mails with other mail servers (not shown) on SMTP, simple mail transfer protocol, and acts as a SMTP and POP, post office protocol, or IMAP, Internet message access protocol, server for the user terminals 102.

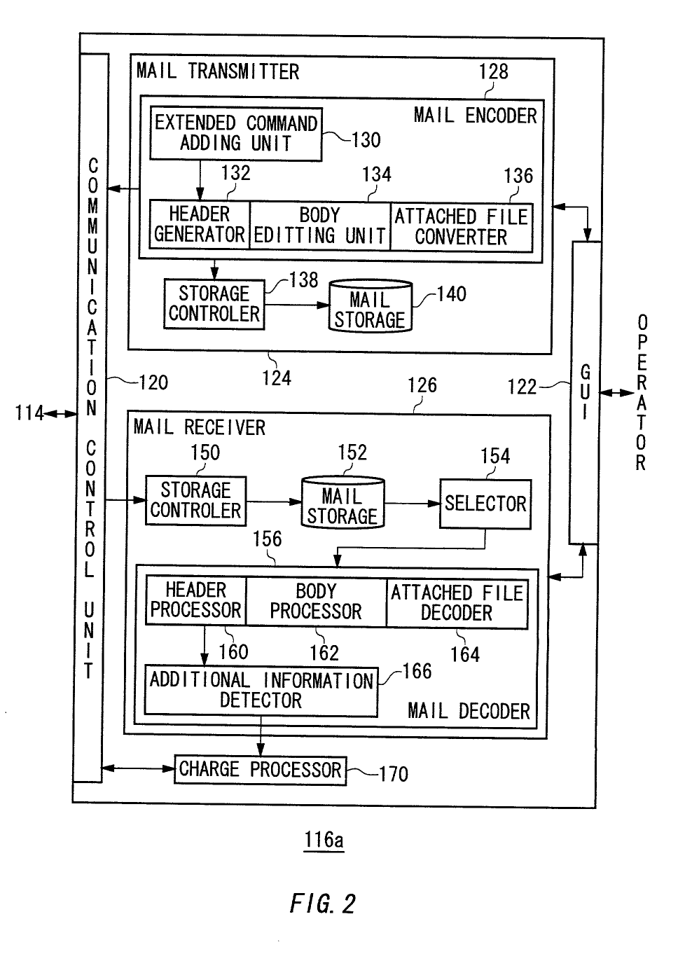

FIG. 2 is a block diagram of an e-mail apparatus 116a, which is a terminal 116 in the advertisement mail site 112. Each block in the e-mail apparatus 116a may be implemented with a CPU, memory and an e-mail related program loaded in the memory. In the figure, however, the blocks are not divided in terms of hardware and/or software component, but of function. The skilled in the art can therefore understand many combinations of hardware and software components can achieve the function of each block.

The e-mail apparatus 116a mainly comprises a communication control unit 120, which may be a LAN card, to communicate with the mail/Web server 114, GUI or graphical user interface 122 to serve for an operator, a mail transmitter 124 to process e-mail transmission, a mail receiver 126 to process e-mail reception and a charge processor 170 to manage the charge to an e-DM sponsor based on an additional information mentioned later. The GUI 122 may include any software/hardware including an input device such as a keyboard or a mouse, a display device, a screen for inputting operator's direction to the terminal and so on.

The mail transmitter 124 comprises a mail encoder 128 and a storage controller 138 to put an e-mail generated by the mail encoder 128 to a mail storage 140. The mail encoder 128 comprises a header generator 132 to generate an e-mail header, a body editing unit 134 to generate an e-mail body and an attached file converter 136 to convert a designated file to be attached to an e-mail to a text file based on MIME and the like format. The header generator 132, the body editing unit 134 and the attached file converter 136 can be realized by known art, but a new type e-mail is generated by an extended command adding unit 130.

The extended command adding unit 130 embeds a command in an e-mail header to acquire the view duration of an e-mail at the user terminal 102. To achieve this, the below script,

X-reply-view-duration: ID=A0

may be embedded to a user definition line starting with “X-” to let the user terminal 102 return the view duration. In the above script, “reply-view-duration” is the command body and “ID=A0” is an ID of the e-mail uniquely endowed thereto. Instead of the view duration, view start and end times may be acquired by the following two-line script.

X-reply-view-starttime: ID=A0

X-reply-view-endtime: ID=A0

In any case, the command is included in the e-mail, which is transmitted to the user terminal 102 via the communication unit 120 and the mail/Web server 114. The view duration and the view start and end times are both hereinafter mentioned as “view duration” unless otherwise indicated.

The mail receiver 126 comprises a storage controller 150 to put a received e-mail to a mail storage 152, a selector 154 to select from received e-mails an e-mail specified by an operator and a mail decoder 156 to decode and display the selected e-mail. A header processor 160 in the mail decoder 156 interprets and processes the e-mail header. A body processor 162 restores the e-mail body. An attached file decoder 164 converts back the attached file to its original file format. The header processor 160, the body processor 162 and the attached file decoder 164 correspond to the header generator 132, the body editing unit 134 and the attached file converter 136 of the mail encoder 128, respectively. The header processor 160 handles the header itself and at the same time sends the header to an additional information detector 166. The header processor 160 may be a conventional one and entrusts the process regarding the view duration to the additional information detector 166.

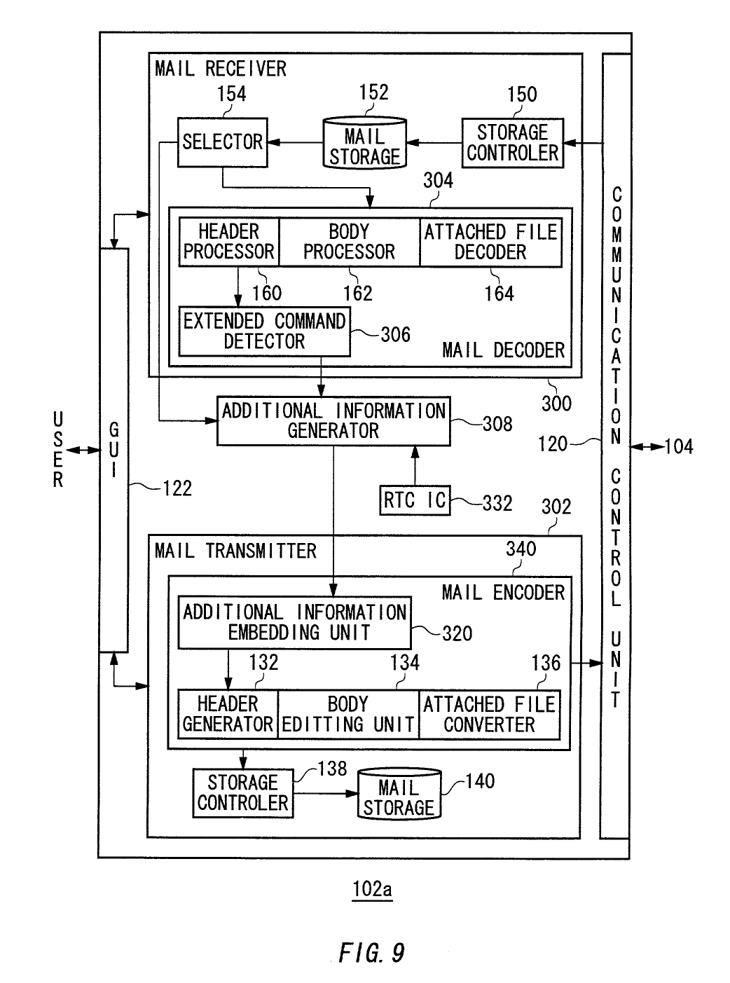

The additional information detector 166 detects the view duration measured at the user terminal responsive to the command and imprinted in the header of a reply e-mail. The user terminal 102, which is described in FIG. 9, adds the following script in the header, for example, to show that the duration was “one minute and 25 seconds”.

X-view-duration: 00:01:25₁₃ID=A0

In the same manner, the start and end times can be implemented as follows.

X-view-start: Jun. 20,2000 07:12:14 AM: ID=A0

X-view-end: Jun. 20,2000 07:13:39 AM: ID=A0

The start and end times can suggest the life style of the user. The advertisement or e-DMs of twenty-four hour shops may be effective for a user who reads e-mails late in the nights. The view duration detected at the additional information detector 166 is sent to the charge processor 170.

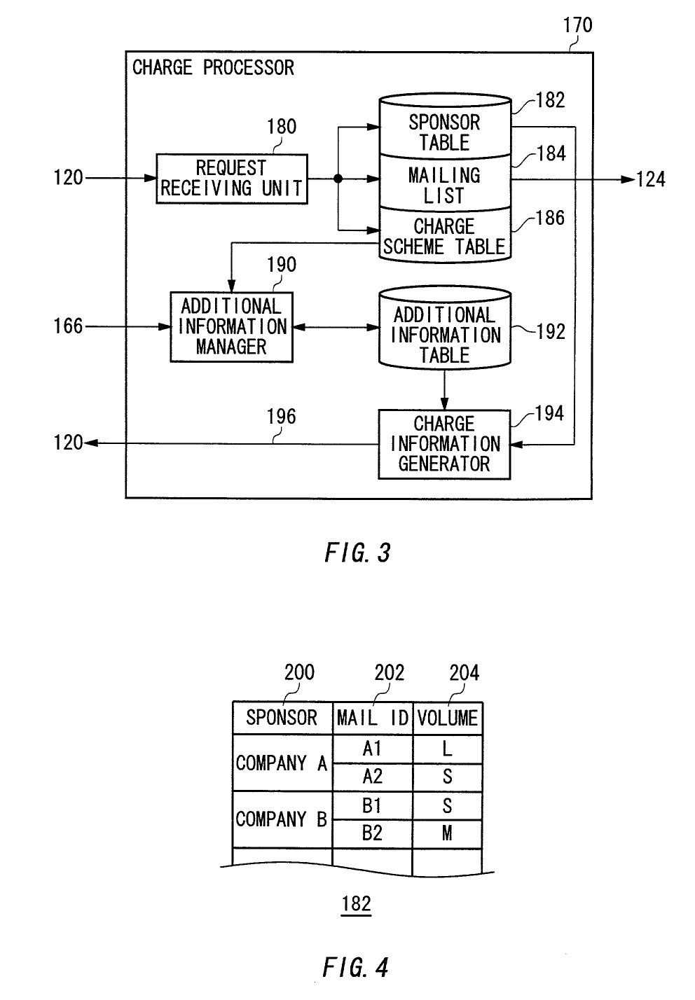

FIG. 3 illustrates the charge processor 170. A request receiving unit 180 receives requests from sponsors such as the site 108 of Company A and stores respective part of the requests in a sponsor table 182, a mailing list 184 and a charge scheme table 186. The requests may be naturally received in an offline manner.

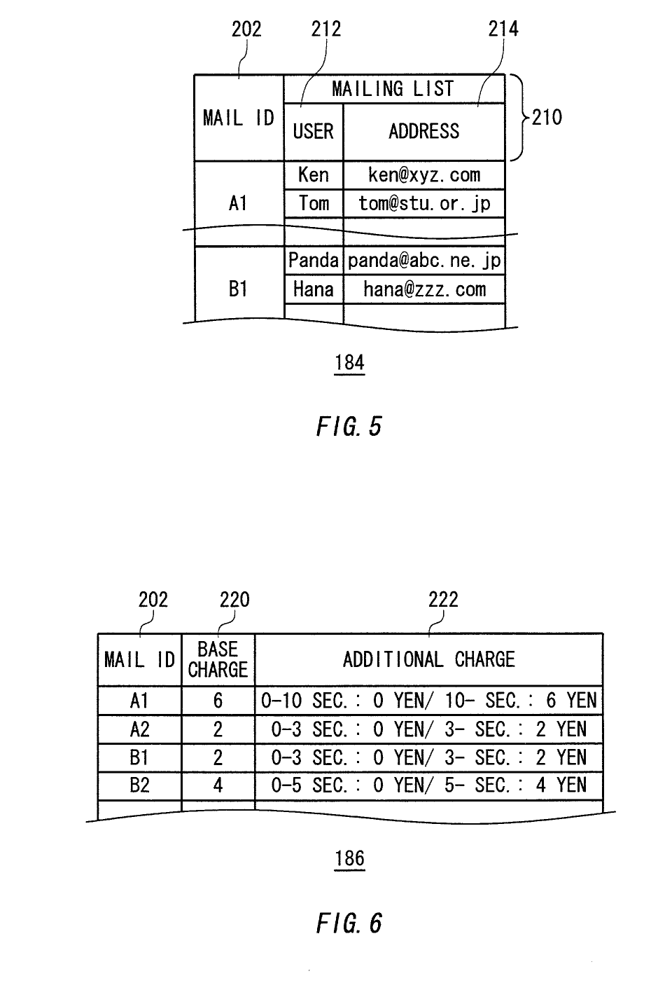

FIGS. 4, 5 and 6 show the data structure of the sponsor table 182, the mailing list 184 and the charge scheme table 186, respectively. The sponsor table 182 comprises a sponsor column 200 recording sponsors such as “Company A”, a mail ID column 202 recording IDs assigned to requested e-mails and a volume column 204 describing the data size of the e-mails. The data size here is classified to three types, L, M and S. In the figure, The Company A has requested to deliver e-mails A1 and A2, which are classified to size L and S, respectively. The size or volume may be byte size, the number of lines and so on.

The mailing list 184 is a target user list designated by a sponsor for each e-mail or e-DM and comprises a mail ID column 202 and mailing list column 210, the latter of which in turn comprises a user column 212 and address column 214. The Company A, for example, requests to the agent to send e-mail A1 to users Ken, Tom and others. In one embodiment, the target user list may be decided locally at the advertisement mail site 112 by picking up the members of the site and the like.

The charge scheme table 186 shows the charge for the transmission of e-DMs and comprises a mail ID column 202, a base charge 220 and an additional charge 222. The e-mail A1, for example, has a basic charge per one user being “6 yen”, an additional charge for the view duration in the range of 0-10 seconds being “0 yen” and in the range of 10 and more seconds being “6 yen”. The e-mail A2, for another example, has a basic charge being “2 yen”, an additional charge for the view duration in the range of 0-3 seconds being “0 yen” and in the range of 3 and more seconds being “2 yen”. Each mail has its own charge schedule as the volume of the e-mail is taken into consideration. Short e-mails can be read in relatively short time even when the user read it intensively. Long e-mails, on the other hand, take relatively long time even when the user just gave a glance. The additional charge for longer e-mails therefore is set relatively low. The basic charge for longer e-mails, however, is set relatively high, as communication cost is high for such mails.

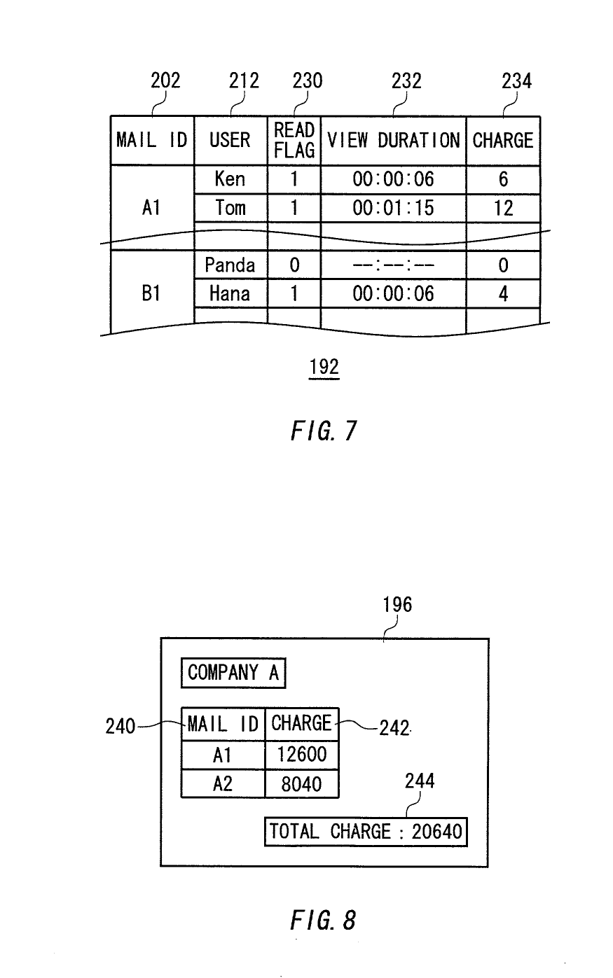

Referring back to FIG. 3, an additional information manager 190 generates an additional information table 192 based on the view duration reported from the additional information detector 166 and the charge scheme table 186. FIG. 7 shows the data structure of the additional information table 192, which comprises a mail ID column 202, a user column 212, a read flag column 230, a view duration column 232 and a charge column 234. User “Ken”, for example, has opened or read the e-mail A1 and the view duration was “6 seconds”. The charge for delivering the e-mail to this user is identified as “6 yen” according the charge scheme table 186. The information to be written in the read flag column 230 may be made with conventional art. The view duration column 232 may be used as the read flag column 230 so that the read flag column 230 may be deleted.

In FIG. 3, a charge information generator 194, referring to the additional information table 192, sends a bill to each sponsor in an online manner. FIG. 8 illustrates a bill 196 for the Company A. The bill 196 has a mail ID column 240 identifying e-mail IDs requested from the sponsor, a charge column 242 indicating total charge for each e-mail and the total charge 244 for the service. The functions of the e-mail apparatus 116a in the mail-ad site 112 have been described.

FIG. 9 is a block diagram of an e-mail apparatus 102a, which is a user terminal 102. In this figure, the same components as FIG. 2 are given with the same numerals and not described here.

A mail decoder 304 in a mail receiver 300 has an extended command detector 306 instead of the additional information detector 166 provided in the mail receiver 126 of the e-mail apparatus 116a, as e-mails sent from the advertisement mail site 112 have a view duration acquiring command therein. The extended command detector 306 detects the command below or the like and initiates an additional information generator 308 when the command is detected.

X-reply-view-duration: ID=A0

The additional information generator 308 measures the view duration using a clock IC 332, which may be a RTC or real time clock. The IC 332 may be substituted by an interval timer or a software timer.

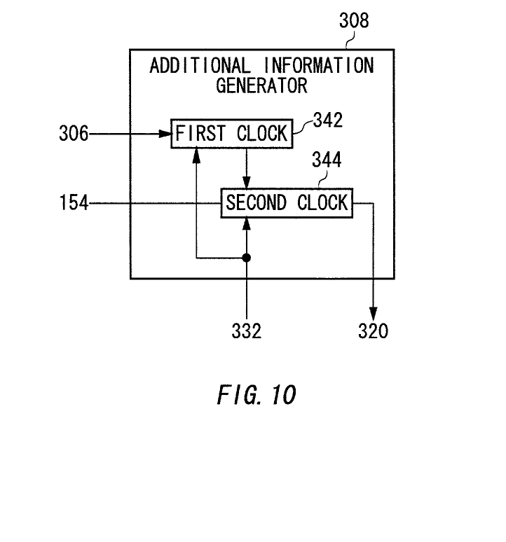

FIG. 10 shows the additional information generator 308. A first clock 342 latches the present time outputted by the clock IC 332 on detecting the command. The latched time is the view start time, which is reported to a second clock 344. When the user selects another e-mail, the selector 154 reports the fact to the second clock 344, which, on receipt of the report, latches the present time outputted by the clock IC 332. The latched time is the view end time, which is reported together with the start time to an additional information embedding unit 320. Alternately, the true view duration calculated by extracting the start time from the end time is reported to the additional information embedding unit 320.

Referring back to FIG. 9, the additional information embedding unit 320 in the mail transmitter 302, after receiving the view duration, embeds it in an e-mail header as one line script as

X-view-duration: 00:01:25_ID=A0 or two-line script as

X-view-start: Jun. 20,2000 07:12:14 AM: ID=A0

X-view-end: Jun. 20,2000 07:13:39 AM: ID=A0.

The e-mail thus generated is sent back to the e-mail apparatus 116a in the advertisement mail site 112.

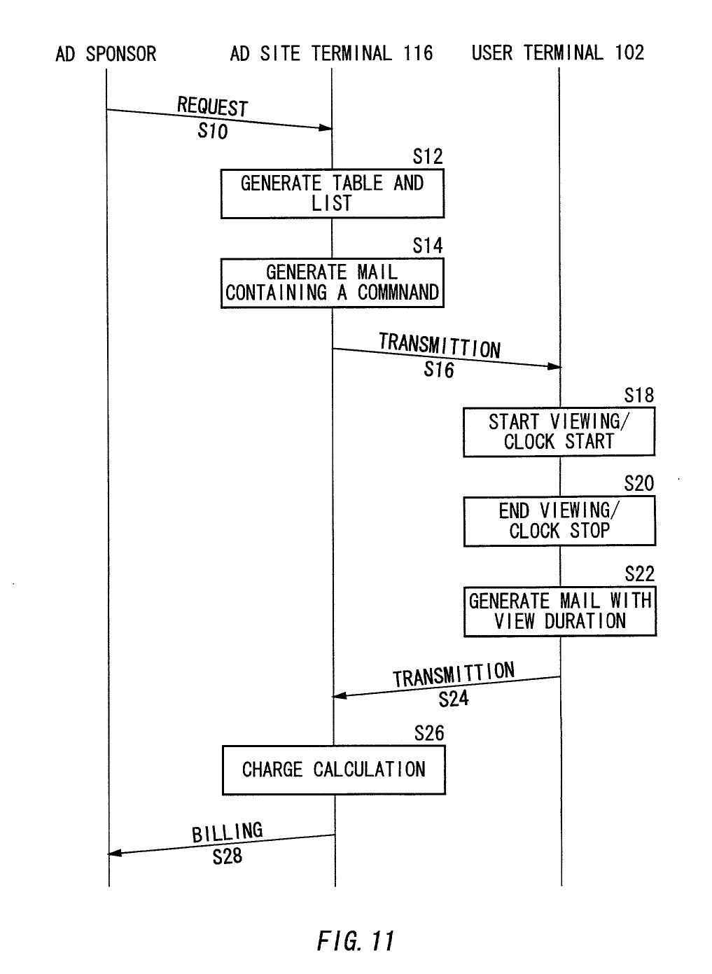

FIG. 11 shows a process flow realized with the above configuration. A sponsor first requests the advertisement mail site 112 for the transmission of an e-DM to multiple users (S10). The e-mail apparatus 116a generates the tables and lists shown in FIG. 3 (S12), generates an e-DM containing a view duration acquiring command (S14), and sends the e-DM to the users (S16).

A user opens the e-DM and starts viewing, which triggers the view duration measurement (S18). The view end time is obtained when the user selects another e-mail (S20). A reply e-mail containing the view duration is generated (S22) and sent to the terminal 116 in the advertisement mail site 112 (S24).

The charge processor 170 calculates the charge based on the view duration (S26) and sends the bill to the sponsor (S28).

The above embodiments can help estimate the users' attention objectively. Sponsors are encouraged to issue e-DM requests. Charge for the service is reasoned on an objective view duration basis. These effects together can promote the present aspect of the electronic commerce.

Although the present invention has been described by way of exemplary embodiments, it should be understood that many changes and substitutions may be made by those skilled in the art without departing from the spirit and the scope of the present invention. A few other embodiments are now explained.

The components of FIG. 2 and FIG. 9 can be combined together to provide a general-purpose e-mail apparatus or program. The program may be sold as a package software which works as an independent program. Alternately, the program may work as a plug-in type one. In the latter case, conventional functions in FIGS. 2 and 9 may be deleted.

It is possible to make a market analysis by recording and conducting data-mining on the view duration of each user or of the users collectively for each e-DM. The mailing list 184 may be optimized based on the analysis.

From a privacy point of view, it should be considered that there may be unpleasant users regarding the view duration inspection. The e-mail apparatus 102a at the user end may be provided with a functional block to refuse sending a reply mail to the sender. Users may be urged not to refuse the reply by awarding incentives such as points and prizes.

What is claimed is:

1. An electronic mail apparatus comprising:
a mail transmitting unit which sends e-mails;
a mail receiving unit which receives e-mails; and
a charge processor which manages charge of service for transmitting e-mails;
wherein the mail receiving unit includes an additional information detector to detect information regarding start time and end time of view of the received e-mail, the information having been embedded in the received e-mail, and
wherein the charge processor includes a charge information generator to calculate the service charge for transmitting the e-mail based on the duration of the view.

2. The apparatus of claim 1, wherein the mail transmitter further includes an extended command addition unit which embeds in the e-mail to be transmitted a command to instruct to obtain the start time and the end time of the view.

3. The apparatus of claim 1, wherein the charge processor further includes:
a request receiving unit which receives request for distributing advertisement using e-mails;
a table recording a sponsor who issued the request;
a mailing list to be referred for sending the e-mails; and
a charge scheme table which describes the service charge based on the duration of the view of the e-mail containing the advertisement;
wherein the charge information addition unit calculates the charge referring to the detected information and the scheme table.

4. The apparatus of claim 2, wherein the charge processor further includes:
a request receiving unit which receives request for distributing advertisement using e-mails;
a table recording a sponsor who issued the request;
a mailing list to be referred for sending the e-mails; and
a charge scheme table which defines the service charge based on the duration of the view of the e-mail containing the advertisement;
wherein the charge information addition unit calculates the charge referring to the detected information and the scheme table.

5. The apparatus of claim 3, wherein the scheme table defines the charge in a form dependent on volume of the e-mail.

6. The apparatus of claim 4, wherein the scheme table defines the charge in a form dependent on volume of the e-mail.

7. An electronic mail apparatus comprising:
a mail transmitting unit which sends e-mails;
a mail receiving unit which receives e-mails; and
an additional information generator which generates additional information to embed in the e-mails to be sent;
wherein the mail receiving unit includes an extended command detector to detect a command embedded in the received e-mail instructing to obtain start time and end time of view of the received e-mail and
wherein the additional information generator, instructed by the command, generates the information by measuring duration of the view of the received e-mail.

8. The apparatus of claim 7, wherein the additional information generator includes a first clock to record the start time and a second clock to record the end time and wherein the duration is calculated from the start time and the end time.

9. The apparatus of claim 7, wherein the mail transmitting unit forms an e-mail by embedding the additional information when the information is generated and sends the formed e-mail to a sender of the received e-mail.

10. The apparatus of claim 8, wherein the mail transmitting unit forms an e-mail by embedding the additional information when the information is generated and sends the formed e-mail to a sender of the received e-mail.

11. An electronic mail system comprising a first e-mail apparatus and a second e-mail apparatus,
wherein the first apparatus comprises:
a functional block which embeds in an e-mail to be sent to the second apparatus a command to send back information indicating duration of view of the e-mail at the second apparatus; and
a functional block which detects the information sent back from the second apparatus; and
wherein the second apparatus comprises:
a functional block which detects a command embedded in the e-mail sent from the first apparatus; and
a functional block which, instructed by the command, measures the duration of the view; and
a functional block which embeds the measured duration in an e-mail to be sent back to the first apparatus.

12. The apparatus of claim 11, wherein the first apparatus further includes a functional block which generates charge information based on the detected information indicating the duration.

13. An electronic mail communication method comprising:
sending an e-mail from a first apparatus;
receiving the e-mail at a second apparatus;
acquiring duration of view of the e-mail at the second apparatus; and
calculating charge by referring to a predetermined charge scheme using the acquired duration as a key to the scheme.

14. An electronic mail communication method, wherein e-mails are sent accompanying advertisement therein and wherein effect of the e-mails is figured in an objective manner based on duration of view of the e-mails at user terminals.

15. The method of claim 14, wherein the e-mails are sent by an agent acting for a sponsor requesting e-mail advertisement and wherein charge for service is calculated based on the duration.

16. The method of claim 14, wherein the sent e-mails have a command embedded therein beforehand, the command instructing to obtain the duration.

17. The method of claim 15, wherein the charge is defined by reflecting volume of the sent e-mails.
